(19) United States
(12) Patent Application Publication
(10) Pub. No.: US 2009/0211095 A1
(43) Pub. Date: Aug. 27, 2009

(54) Microgrooves as Wick Structures in Heat Pipes and Method for Fabricating the Same

(76) Inventor: Wen-Chun Zheng, San Jose, CA (US)

Correspondence Address: PATENT LAW GROUP LLP, 2635 NORTH FIRST STREET, SUITE 223, SAN JOSE, CA, 95134, US

(21) Appl. No.: 12/035,345

(22) Filed: Feb. 21, 2008

(51) Int. Cl. B23P 6/00

(52) U.S. Cl. 29/890.032

(57) ABSTRACT

Microgrooves (<0.2 mm wide) of various shapes used as wick structures in heat pipes can increase the capillary force to overcome the gravitational force on the working fluid so as to enable large working angles for the heat pipes. The microgrooves can be fabricated by two sequential steps use a first plowshare-like blade to turn up the material for large size grooves and then immediately use a second plowshare-like blade to rebury by the previously turned up material. The microgrooves and the fabrication method can be used to manufacture flat heat pipes (vapor chambers) as well as tubular heat pipes.

### FIELD OF INVENTION

This invention is related to the wick structures, and more specifically to microgrooves (<0.2 mm wide) used as wick structures in heat pipes and method for manufacturing the same.

### DESCRIPTION OF RELATED ART

A heat pipe is a highly efficient heat transfer device that typically includes a vacuum vessel. The vacuum vessel has a wick structure on its inner wall and contains a small quantity of working fluid. When a heat source is applied to an evaporator portion, the working fluid evaporates into vapor that spreads quickly in the vessel. The vapor carries latent heat to a condenser portion and condenses to liquid as the latent heat dissipates to outside of the heat pipe by conduction or convection. The working fluid is transported by the capillary force back to the evaporator portion, thereby completing a two phase heat transfer cycle without consuming any power.

Generally, heat pipes are made from highly thermally conductive metals such as stainless steel, copper, and aluminum. Working fluids that are compatible with these heat pipe materials include water, mercury, and other chemicals depending on the working temperature range. Copper and pure water are the most common combination for the heat pipes used in computer and electronic systems. To overcome gravity so that evaporator and condenser can be in any orientation, the wick structure in a heat pipe provides the pumping mechanism that transports the working fluid back to the evaporator portion.

Rather than having a round or oblong tube shape of a typical heat pipe, a flat heat pipe has a plate shape and is usually made of metal sheets or plates. The flat heat pipe has a vapor chamber enclosing a working fluid. The vapor chamber has capillary structures on the inner surfaces of the top and bottom plates. The evaporator portion is one or more small areas on the outer surface of either the top or bottom plate that contact one or more heat sources (e.g., an electronic device). All other areas of the top and bottom plates serve as the condenser portion.

Typical capillary structures in heat pipes include sintered metal powders, fibers, meshes and grooves. Heat pipes with sintered metal powders, such as a sintered copper powder, have great capillary force so that they can be used at any orientation. However, it is complex and expensive to manufacture this type of heat pipes, and the thermal resistance is higher than other type heat pipes because the sintered metal powders are porous. Heat pipes made with fibers and meshes work at small angles. Furthermore, they are also expensive and complicated to be manufactured. When compared with the aforementioned technologies, heat pipes with grooves are inexpensive and easy to manufacture. However, they are only used at horizontal condition or small angles because the conventional grooves do not provide enough capillary force.

Heat pipes with grooves, usually V-shape or other shapes, are generally manufactured by a seamless pipe process such as extrusion. However, the size of the grooves are large (about >0.35 mm wide) relative to heat pipe dimensions due to the limitations on the tooling. The resulting capillary force is not large enough to pump the working fluid back to the upper condenser at large working angles. Therefore, a method for fabricating microgrooves (about <0.2 mm wide) is needed to take advantage of the low cost and ease of manufacturing of heat pipes with grooves, as well as to improve the thermal performance of the heat pipes.

### BRIEF DESCRIPTION OF THE DRAWINGS

FIG. 1 illustrates a process for forming microgrooves in one embodiment of the invention.

FIG. 2 illustrates a process for forming microgrooves in another embodiment of the invention.

FIG. 3 illustrates microgrooves on a plate in one embodiment of the invention.

FIG. 4 illustrates a flat heat pipe with microgrooves in one embodiment of the invention.

FIG. 5 illustrates a production line of making pipes with inner-threads using seam-welding.

FIG. 6 illustrates a method for making microgrooves on a strip in the production line of FIG. 5 in one embodiment of the invention.

FIG. 7 illustrates an oblong heat pipe in one embodiment of the invention.

FIG. 8 illustrates a flat heat pipe in one embodiment of the invention.

Use of the same reference numbers in different figures indicates similar or identical elements.

### SUMMARY

In accordance with the invention, one embodiment of a method for fabricating microgrooves on a metal plate or strip includes two sequential steps in a single pass. A first blade with first multi-plowshares is used in the first step to turn up material on the plate or strip to form large grooves, and then a second blade with second multi-plowshares is used in the second step to rebury the large size grooves with the material turned up in the first step to form microgrooves. The microgrooves can have various shapes and are used as wicks in heat pipes. The microgrooves are formed from the relative movement between the blades and the plate or strip into which the plowshares enter. As the microgrooves can be fabricated with very small dimensions, which are controlled by the amount of the reburied material, the heat pipes can perform at large working angles due to increased capillary force.

In one embodiment, microgrooves on plates are manufactured with fluting or slotting machines where the plates are fixed on the worktable and the blades moves along a track on the machine. In one embodiment of the method, the microgrooves are formed along two directions so they intersect and allow a working fluid to travel between the microgrooves. The plates with the microgrooves can be used to make flat heat pipes or vapor chambers.

In one embodiment, microgrooves are manufactured on a metal strip such that the blades are fixed and a reel of the metal strip is unwound forward. Tubular heat pipes with the microgrooves can then be easily manufactured by integrating the above process in a conventional pipe production line using seam-welding such as high frequency induction heating (HFI). In order to have a better flow mechanism, regular V-shape grooves in another direction can be first formed by rolling to allow the working fluid to flow across the microgrooves.

### DETAILED DESCRIPTION

It is well known that narrow grooves provide large capillary force and therefore large working angle for heat pipes. Grooves of various shapes in current heat pipes are typically formed by extrusion and are generally greater than 0.3 mm wide. The microgrooves in accordance with the invention are mini/micro-scaled grooves that are less than 0.2 mm wide. The two sequential steps in accordance with the invention may be the only available approach for mass producing grooves of this scale at present time. The principle is as simple as a farmer plowing a trench in the soil and then reburying the trench after seeds are planted. To accomplish the process, two blades are used. A first blade of first multi-plowshares is used in the first step to turn up material on a metal plate or strip to form large grooves, and then a second blade with second multi-plowshares is used in the second step to rebury the large size grooves with the material turned up in the first step to form microgrooves. The two sequential steps are simultaneously applied in a single pass. As more material is reburied, the groove size becomes smaller. The microgrooves are formed from the relative movement between the blades and the plate or strip into which the plowshares enter. The plate or strip is typically a malleable metal such as copper, copper alloy, aluminum, or aluminum alloy when the method uses cold-pressing steps. Alternatively, the plate or strip can be of harder metal such as stainless steel when the method uses hot-pressed steps.

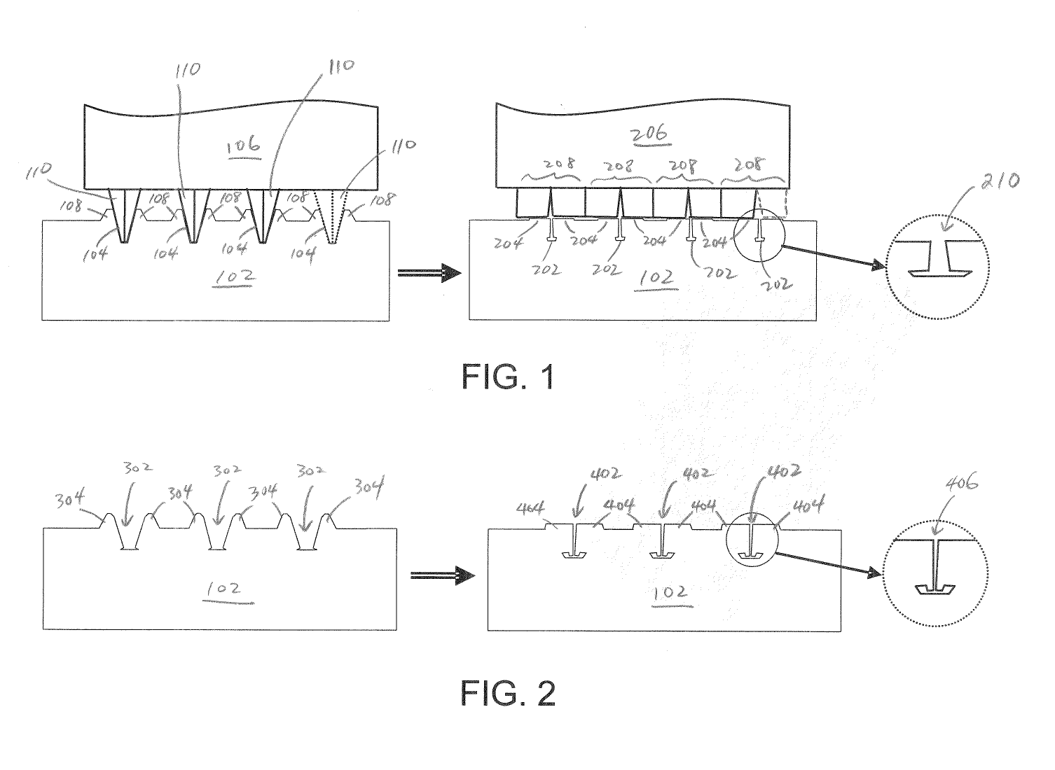

The left of FIG. 1 shows a cross-section of metal plate 102 with large grooves 104 after the first step in one embodiment of the invention. A first blade 106 turns up material on plate 102 without flaking to form curbs 108 collected on both sides of each groove 104. Multi-plowshares 110 (shown partly with phantom lines) at the bottom of first blade 106 have the same projection view as the groove profile of large grooves 104.

The right of FIG. 1 shows a cross-section of metal plate 102 with microgrooves 202 after the second step in one embodiment of the invention. Curbs 108 turned up by the first step are reburied into large grooves 104 and reshaped into curbs 204 by multi-plowshares 206 (shown partly with phantom lines) of second blade 208. The height of blade 206 over plate 102 controls the height of curb 204, which in turn determines the width of microgrooves 202. As more material is reburied, microgrooves 202 become narrower. One of the microgrooves 202 is enlarged and indicated by reference number 210. It is emphasized that the two sequential steps can occur simultaneously in a single pass of plate 102 to form microgrooves 202.

The left of FIG. 2 shows a cross-section of metal plate 102 with large grooves 302 of another design after the first step in one embodiment of the invention. The first blade turns up material on plate 102 without flaking to form curbs 304 collected on both sides of each groove 302. The multi-plowshares at the bottom of the first blade have the same projection view as the groove profile of large grooves 302.

The right of FIG. 2 shows a cross-section of metal plate 102 with microgrooves 402 after the second step in one embodiment of the invention. Curbs 304 turned up by the first step are reburied into large grooves 302 and reshaped into curbs 404. The height of the second blade over plate 102 controls the height of curb 404, which in turn determines the width of microgrooves 402. As more material is reburied, microgrooves 402 become narrower. One of the microgrooves 402 is enlarged and indicated by reference number 406. It is again emphasized that the two sequential steps can occur simultaneously in a single pass of plate 102 to form microgrooves 402.

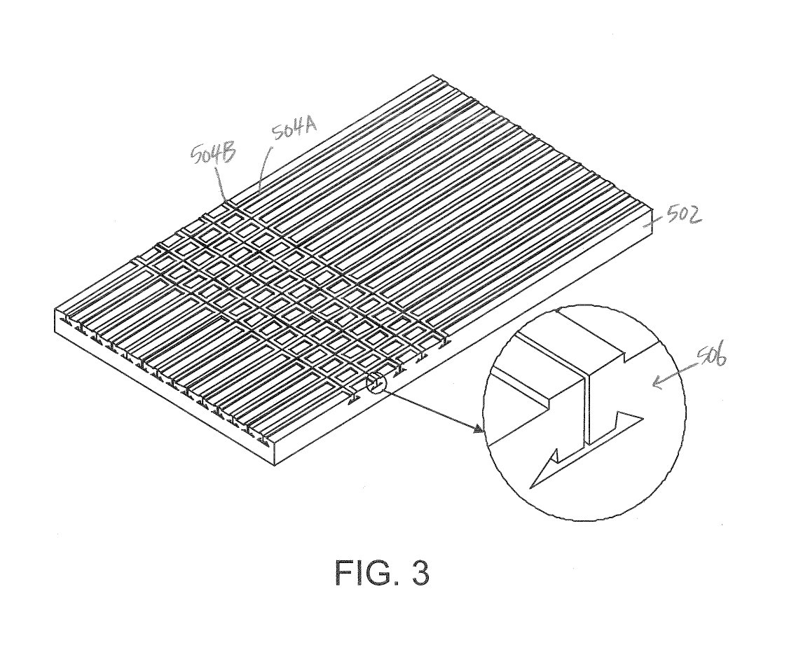

FIG. 3 illustrates a large metal plate 502 with microgrooves 504A (only one is labeled for clarity) along a first direction and microgrooves 504B (only one is labeled for clarity) along a second direction perpendicular to the first direction in one embodiment of the invention. One of microgrooves 504A and 504B is enlarged and indicated by reference number 506. Microgrooves 504A and 504B are formed using the two sequential steps described above. Microgrooves 504A and 504B are formed along two directions so they intersect and allow a working fluid to travel between the microgrooves. Microgrooves on a large plate can be fabricated on fluting or slotting machines where the plate is fixed on the worktable and the blades moves along the track on the machine. The plates with the microgrooves are used to make flat heat pipes or vapor chambers.

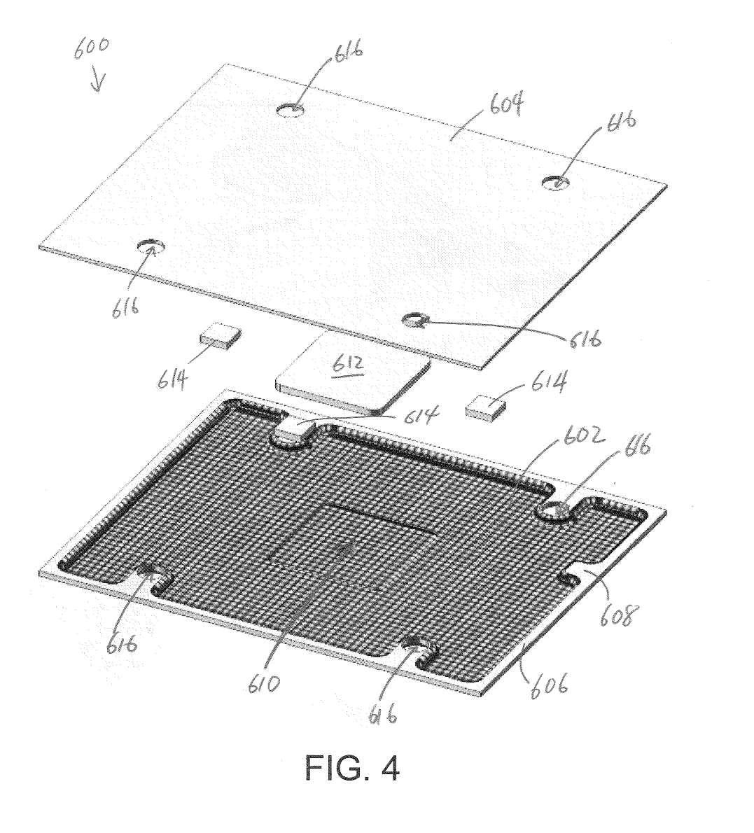

FIG. 4 illustrates a flat heat pipe or vapor chamber 600 with microgrooves 602 in one embodiment of the invention. Flat heat pipe 600 includes a top cover 604 and a bottom cover 606. Bottom cover 606 defines a cavity with a base having a surrounding sidewall. A portion 608 of the sidewall forms a location where a hole can be formed to extract air from the cavity, fill the cavity with a working fluid, and sealed to maintain the vacuum in the cavity.

The base of bottom cover 606 has a pedestal depression 610 that protrudes downward from the base for contacting a heat source below flat heat pipe 600. The base of bottom cover 606 further has microgrooves 602 formed along two perpendicular directions as shown more clearly in FIG. 3. Similarly, top cover 604 has microgrooves 602 (not shown) formed on its inner surface. Microgrooves 602 are formed using the two sequential steps described above.

A spacer 612 is seated in pedestal depression 610 between top cover 604 and bottom cover 606. Spacer 612 adds to the mechanical stiffness of flat heat pipe 600 and provides a heat conductive path from the heat source to top cover 604 to improve heat dissipation.

Spacers 614 are sandwiched between top cover 604 and bottom cover 606 to control the height of the cavity defined between the covers. Holes 616 are defined in top cover 604 and bottom cover 606 for fasteners to mounting flat heat pipe 600. For example, flat heat pipe 600 is mounted to an electronic board to cool a processor in contact with pedestal depression 610.

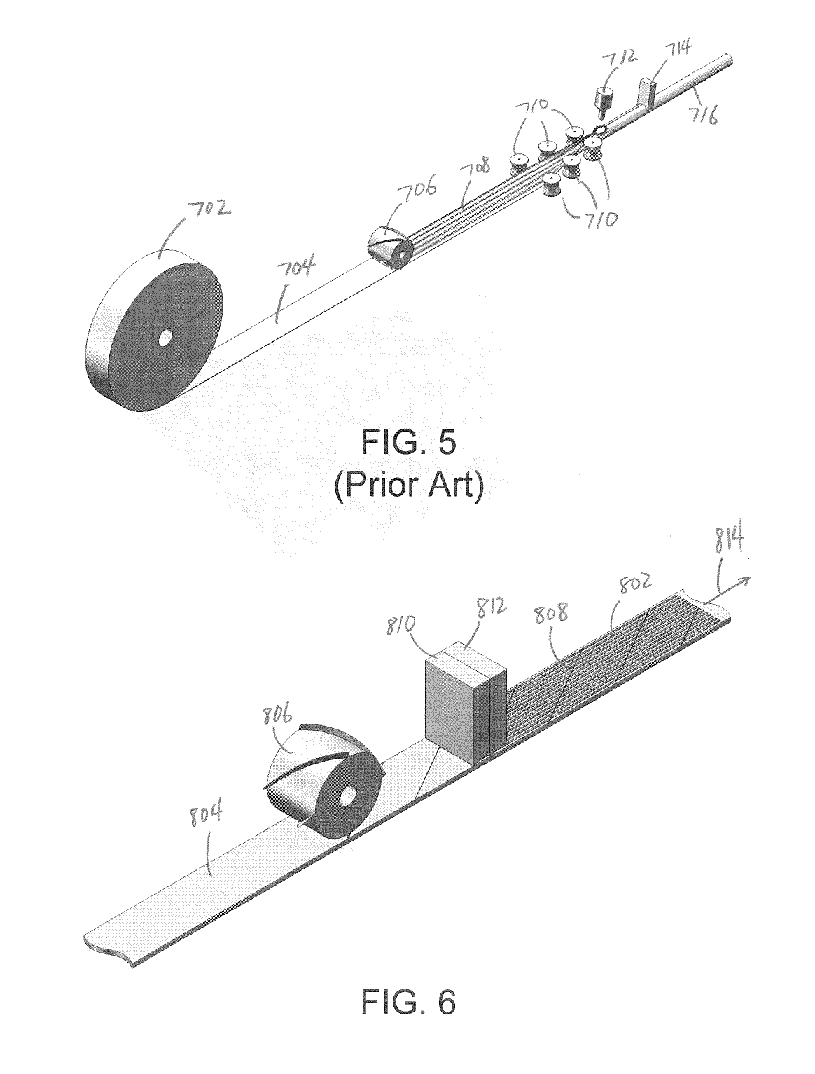

FIG. 5 illustrates a conventional production line of making pipes with inner-threads 708 (only one is labeled for clarity) using a longitudinal seam weld. A reel 702 of metal strip 704 is fed under a roller 706. Roller 706 forcibly engages the top surface of strip 704 to form inner-threads 708. Strip 704 is next fed through a series of forming rollers 710 that bend strip 704 into a tube of the desired cross-section (e.g., round, oblong, square, rectangular). A welder 712 joins the seam of the tube and a blade 714 trims weldment 716 from the seam to produce a pipe 716. Welder 712 uses high frequency induction heating (HFI) welding or another similar welding process.

FIG. 6 illustrates another way to make microgrooves 802 on a reeled metal strip (or plate) 804. By fixing a first blade 810 and a second blade 812, microgrooves 802 can be fabricated when strip 804 moves forward under the blades by a pulling force 814. As described above for the two sequential steps, first blade 810 has first multi-plowshares that open large grooves by turning up the material of strip 804, and second blade 812 has second multi-plowshares that rebury the large grooves to form microgrooves 802.

Strip 804 is optionally fed under a roller 806 to form optional grooves 808 (only one is labeled for clarity) that are diagonal to the travel of strip 804. Diagonal grooves 808 are of typical shape and size like grooves found in a conventional heat pipe. For example, diagonal grooves 808 are V-grooves and have a width greater than 0.3 mm. When included, diagonal grooves 808 interconnect microgrooves 802 so that a working fluid in the resulting heat pipe can travel via diagonal grooves 808 between microgrooves 802. This allows the resulting heat pipe to function not just along the direction of microgrooves 802 but essentially along any direction.

In one embodiment, the process of FIG. 6 is integrated in the conventional production line of FIG. 5 to make microgroove heat pipes. Referring to FIG. 5, strip 804 is fed through rollers 710 that bend the strip into a tube of the desired cross-section, welder 712 joins the seam of the tube, and blade 714 trims the weldment from the seam to produce a tubular heat pipe. Alternatively, the fabrication of microgrooves 802 in FIG. 6 can be performed independently from the fabrication of the microgroove heat pipes in FIG. 5 in two separate production lines. If so, the unwound strip 804 with microgrooves 802 would replace reel 702 of strip 704 in the production line of FIG. 5.

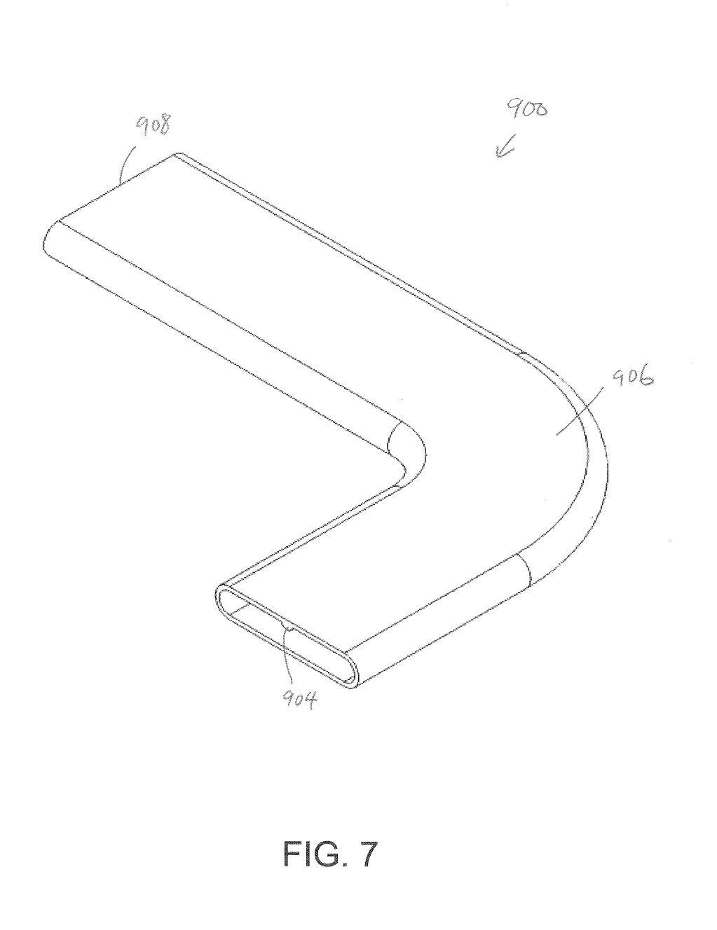

FIG. 7 illustrates a tubular heat pipe 900 with microgrooves in one embodiment of the invention. Tubular heat pipe 900 is made from strip 804 with microgrooves 802 and optionally grooves 808 as described above in reference to FIG. 6. Strip 804 is formed into tubular heat pipe 900 with a desired cross-section using a conventional method. In one embodiment, tubular heat pipe 900 has an oblong cross-section. Oblong heat pipe 900 can optionally be bent to a desired shape. In one embodiment, oblong heat pipe 900 includes a bend 906 (e.g., a 90 degree bend). Ends 908 (only one is shown for clarity) of oblong heat pipe 900 are sealed by a conventional method. A weldment 904 shows where strip 804 is seam-welded to form tubular heat pipe 900.

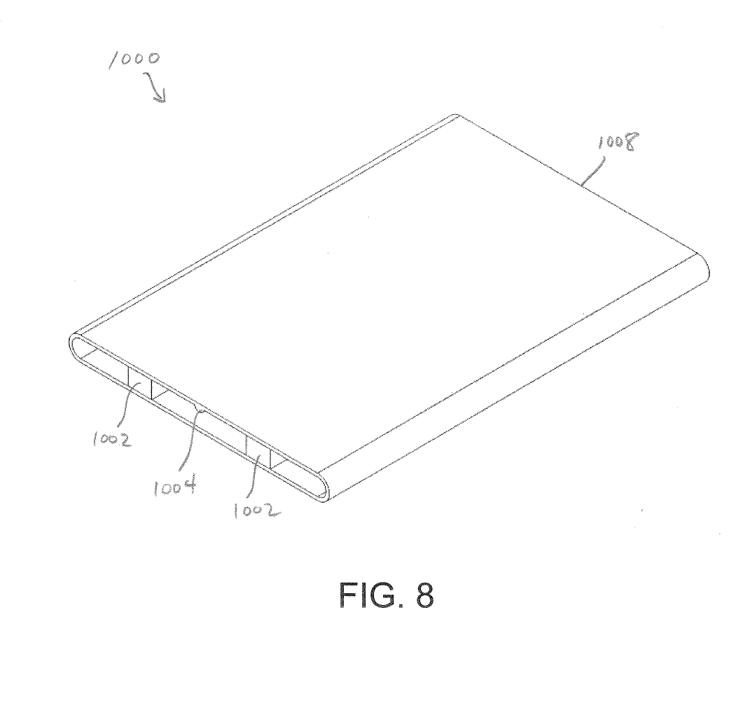

FIG. 8 illustrates a flat heat pipe/vapor chamber 1000 in one embodiment of the invention. Flat heat pipe 1000 can be made from plate 502 with microgrooves 504A and 504B as described above in reference to FIG. 3. Spacers 1002 are first fixed on plate 502. Plate 502 is formed into flat heat pipe 1000 with a desired cross-section using a conventional method. The top and the bottom of flat heat pipe 1000 are separated by spacers 1002. Ends 1008 (only one is shown for clarity) of flat heat pipe 1000 are sealed by a conventional method. A weldment 1004 shows where plate 502 is seam-welded to form flat heat pipe 1000.

Various other adaptations and combinations of features of the embodiments disclosed are within the scope of the invention. For example, the microgrooves of the present invention are formed from the relative motion between the plate or strip and the blades. Thus, the plate/strip can move against stationary blades, the blades can move against stationary plate/strip, or they can all move relative to each other. Numerous embodiments are encompassed by the following claims.

What is claimed is:

1. A method for fabricating microgrooves for use as a wick structure in a heat pipe, comprising:
plowing large grooves by turning up materials on one of a plate and a strip with a first blade of first multi-plowshares; and
reburying the large grooves with the material turned up previously to form microgrooves with a second blade of second multi-plowshares.

2. The method of claim 1, wherein said plowing and said reburying occur by moving said one of a plate and a strip relative to the first and the second blades.

3. The method of claim 1, wherein said plowing and said reburying occur by moving the first and the second blades relative to said one of a plate and a strip.

4. The method of claim 1, wherein the said one of a plate and a strip is selected from the group consisting of copper, copper alloy, aluminum, and aluminum alloy.

5. The method of claim 1, further comprising:
heating said one of a plate and a strip before said plowing and said reburying.

6. The method of claim 1, wherein the microgrooves are aligned along two directions so they intersect and interconnect.

7. The method of claim 1, wherein said plowing and said reburying occur on one of fluting and slotting machines.

8. The method of claim 1, wherein said one of a plate and a strip forms at least one of a top cover and a bottom cover, the method further comprising:
mounting spacers on the bottom cover; and
mounting the top cover on the bottom cover to form a flat heat pipe.

9. The method of claim 8, wherein the bottom cover further comprises a pedestal depression, wherein one of the spacers is located in the pedestal depression.

10. The method of claim 8, wherein the microgrooves are aligned along two directions so they intersect and interconnect.

11. The method of claim 1, further comprising:
forming said one of a plate and a strip into a tube; and
welding a seam of the tube to form a tubular heat pipe.

12. The method of claim 11, wherein the tubular heat pipe has a cross-section selected from the group consisting of round, oblong, square, and rectangular.

13. The method of claim 11, wherein said forming and said welding occur on a pipe production line integrated with said plowing and said reburying.

14. The method of claim 11, wherein said forming and said welding occur on a production line separate from another production line with said plowing and said reburying.

15. The method of claim 11, further comprising, prior to said forming said one of a plate and a strip into a tube:
forming additional grooves that intersect and interconnect the microgrooves.

16. The method of claim 15, further comprising:
bending the tubular heat pipe to form a bend in the tubular heat pipe.

17. The method of claim 11, further comprising, prior to said forming said one of a plate and a strip into a tube:
mounting spacers on said one of a plate and a strip;
wherein said forming said one of a plate and a strip into a tube causes a top surface and a bottom surface to be separated by the spacers, and the microgrooves are aligned along two perpendicular directions.

18. The method of claim 1, further comprising:
setting a height of the second blade for said reburying to control the amount of the material reburied into the large grooves and therefore the width of the microgrooves.

19. The method of claim 18, wherein the microgrooves have a width less than 0.2 mm.
